(19) United States
(12) Patent Application Publication
(10) Pub. No.: US 2009/0279211 A1
(43) Pub. Date: Nov. 12, 2009

(54) Bearing apparatus for a hard disk drive

(75) Inventors: Mark Spencer Seymour, Felton, CA (US); Brian Phillips, San Jose, CA (US)

Correspondence Address: SAILE ACKERMAN LLC, 28 DAVIS AVENUE, POUGHKEEPSIE, NY, 12603, US

(73) Assignee: SAE Magnetics (HK) Ltd.

(21) Appl. No.: 12/151,462

(22) Filed: May 7, 2008

(51) Int. Cl. G11B 5/55

(52) U.S. Cl. 360/265.6

(57) ABSTRACT

A low cost method of attaching an actuator arm assembly to a single head hard disk drive that has a reduced part count The actuator arm assembly includes a suspension arm stamped from a metal and a pivot bearing cartridge contained by a reduced mass outer sleeve.

### BACKGROUND OF THE INVENTION

(1) Technical Field

The present invention relates generally to hard disk drives (HDD), and more particularly to an improved device for mounting a pivot bearing to an actuator arm of a HDD.

(2) Description of the Prior Art

For the past several years, data storage methods have followed a tendency of escalating storage capacity while also shrinking the physical size occupied by its storage capacities. Introduction of ever more powerful computer hardware and software has contributed to increasing market pressures for less expensive, larger capacity and smaller packaging in disk drives. Storage device manufacturers make every effort to achieve any possible incremental cost savings that can be reasonably achieved without loss of technical performance and reliability.

A head disk assembly for a hard disk drive employs a rotary actuator apparatus including a pivot shaft that defines an actuator axis of rotation. The HDD is a device manufactured with a high degree of precision. Several fastening methods for holding the parts together are used. Generally, fasteners such as screws were used to enable the completed product to be serviced when defective. As anticipated, however, the inclination within the industry was to merely reject defective assemblies rather than rework them that led to a different fastening method using adhesives. This led to a new set of processing problems involving adhesives that are still being evaluated. Outgassing and long term effects on materials within the hard disk drive, connective strength of the adhesive, curing time and adhesive fatigue are a few of such concerns.

Briefly, single head designs for hard disk drives are typically “de-populated multi-head designs. FIG. 1 shows a multi-head magnetic disk drive 100 with a plurality of magnetic hard disks rotating around an axis 101. A carriage device 102 positions each magnetic head slider 107 on a track of each disk. The carriage device comprises a pivoting actuator carriage 104 capable of rotating around an axis 103 and a main actuator coil 105 such as for example a voice coil motor for driving the pivoting actuator assembly 104 to rotate. Carriage 104 includes one or more suspensions arms represented by the top most suspension arm 106.

A single head de-populated design is illustrated in FIGS. 2a-2d showing several methods of securing the rotating bearing of the hard disk drive as presently practiced in present day applications. The bearing 111 shown in FIG. 2a is secured either by using an adhesive between the outer bearing sleeve 112 and actuator arm 113 or by an interference fit between the outer bearing sleeve and the actuator arm. In FIG. 2b a set screw fastener 114 is shown positioned at the side of actuator 115 such to urge the screw fastener against the outer bearing sleeve 116. Another method shown in FIG. 2c illustrates a retaining ring 117 within a recess disposed at the upper end of the outer bearing sleeve 118. The lower end of the bearing sleeve 118 includes a flange having a larger outer diameter, therefore, securing the outer bearing sleeve within the actuator arm 119. FIG. 2d shows yet another method that is similar to FIG. 2c in that the outer bearing sleeve 120 also has a flange at its lower end instead of a recess groove at its upper end, a threaded portion is provided to secure the outer bearing sleeve to the actuator arm 121 with a threaded nut fastener 122.

### SUMMARY OF THE INVENTION

The present invention allows an actuator to be made with fewer parts while reducing the total manufacturing cost by simplifying the assembly operation. Moreover, the present invention reduces tolerances in the actuator assembly while improving drive reliability and robustness. The parts and assembly costs for a magnetic disk drive represents a significant portion of the total cost of the drive apparatus.

It is an object of the invention to provide an improved method for the manufacture of a hard disk drive.

It is another object of the invention is to provide a hard disk drive with fewer and less expensive parts while reducing overall manufacturing cost and increasing performance.

It is still another object of the invention to simplify the overall assembly operation of the hard disk drive.

It is still another object of the invention to reduce manufacturing tolerances yet improving drive reliability and robustness.

It is yet another object of the invention is to provide a hard disk drive that does not add mass to the drive system thereby achieving reduction in the access time of the magnetic head to selected data tracks of the rotating disk.

It is still another object of the invention not to introduce foreign material into the disk drive. It will not outgas, corrode, wear, or fall off the suspension.

A novel application of geometries and kinematics design principles are at the center of the present invention. Applying these principles while integrating parts serve the assembly and improves reliability of the pivoting actuator. The design principles provide the full natural tolerance and constraint for the assembly of parts. Parts produced are easier to make, also, function much better as an assembly with zero-stress location.

The foregoing, together with other objects features and advantages of this invention, can be better appreciated with reference to the following specification, claims, and the accompanying drawings.

### BRIEF DESCRIPTION OF THE DRAWINGS

FIG. 1 is a perspective view of a typical multi-head magnetic drive assembly of the prior art.

FIGS. 2a, 2b, 2c and 2d illustrate various prior art methods for attaching a bearing to the actuator arm.

FIG. 3a is a cut-away top perspective view of an outer bearing sleeve of the invention.

FIG. 3b is a cut-away top perspective view of an outer bearing sleeve assembly of the invention.

FIG. 4 is an exploded, cut-away, top perspective view of an outer bearing sleeve, of the invention, as applied to a conventional assembly utilizing a retaining ring.

FIG. 5a is an exploded top view of an outer bearing sleeve, of the invention, as applied to a conventional assembly utilizing a nut fastener.

FIG. 5b is an assembled bottom view of the outer bearing sleeve shown in FIG. 5a.

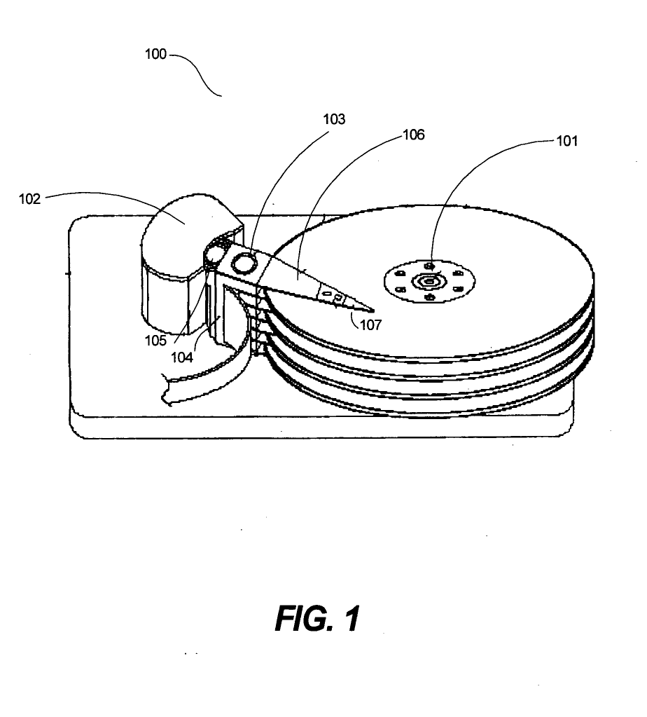

### DETAILED DESCRIPTION OF THE PREFERRED EMBODIMENT

A head disk assembly for a hard disk drive employs a rotary actuator apparatus including a pivot shaft that defines an actuator axis of rotation. In the hard disk drive, a head suspension assembly positions a head slider over a magnetic disk to facilitate reading and writing of information to the disk. Across the spectrum from network servers to personal computers and desktop workstations to notebook systems, the capacity demands placed on hard disk drives are increasing faster than ever before. Because lower costs per megabyte are also desired, the conventional method of adding disks and heads is less and less appropriate. Instead, the primary engineering challenge is to continue to improve drive reliability, cost and useful life.

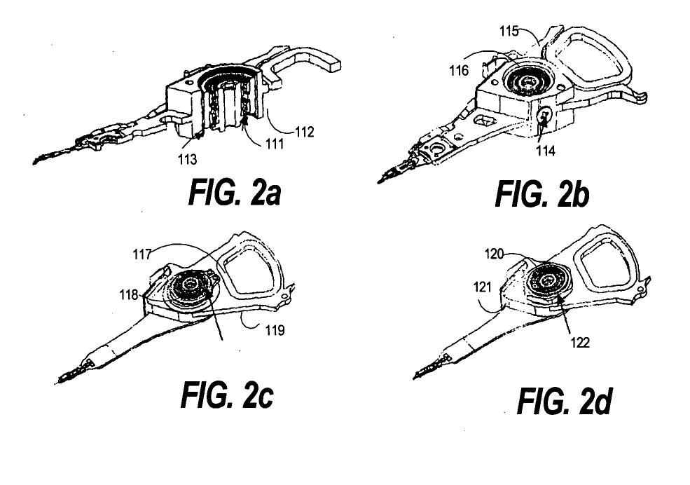

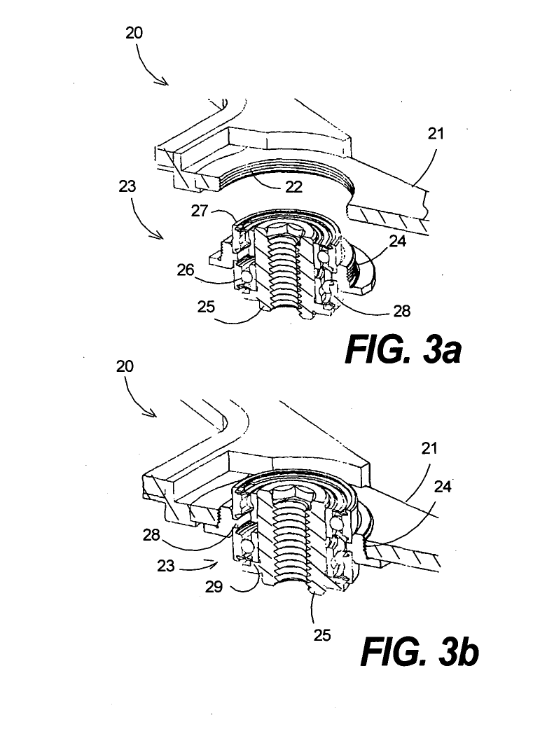

An improved pivot bearing assembly 20 is described. With reference to FIGS. 2a and 2b showing cut-away perspective views of the preferred embodiment where FIG. 2a illustrates an exploded cross-sectional view of the pivot bearing assembly 20 including a suspension arm 21 and a pivot bearing cartridge 22 with a reduced mass outer sleeve 23. The invention allows several novel low cost design improvements for attaching the pivot bearing cartridge 22 to the suspension arm 21. Firstly, the suspension arm is stamped from a metal, either aluminum or steel, while forming its periphery. An internal screw thread 24 is produced in a punched out bore of the suspension arm. Secondly, a matching external thread 25 is formed on the sleeve 26 such that both suspension arm 20 and pivot bearing cartridge 22 can be demountably assembled. The pivot bearing cartridge 22 having an internal spacer 27 formed therein to maintain a space between duplex bearings 28a and 28b principally making contact only with the outer race of each bearing. A conventional inner threaded bushing 29 having a first end outer shaft diameter closely fitting the inner race of bearings 28a and 28b and a second end with a shoulder for providing support for the inner race of lower bearing 28b. The prefered embodiment as described reduces mass of the outer sleeve, hence, results in lower material costs while the threaded assembly reduces the overall part count therefore, simplifying the manufacturing process and further reducing cost.

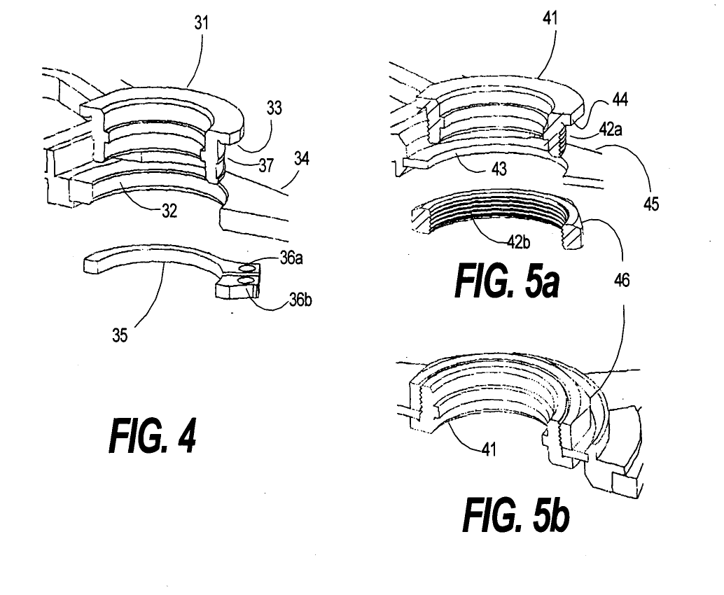

Referring now to FIGS. 4, 5a and 5b showing alternative embodiments, of the invention, that can be applied to conventional attachment methods to reduce assembly cost by decreasing the number of parts used for assembly.

In FIG. 4, showing a cross-sectional exploded view of an outer bearing sleeve 31 to be placed in cavity bore 32 such that flange surface 33 rests on the top surface of suspension arm 34. A conventional retaining ring 34 is expanded by forcing holes 35a and 35b apart with a tool (not shown) and inserted into groove 36 disposed such that the top edge of the groove is contiguous with the bottom surface of the suspension arm, there-at, tighly securing the outer bearing sleeve to suspension arm 34.

Referring now to FIGS. 5a and 5b where 5a is a cross-sectional exploded view of an outer bearing sleeve 41 having an external thread 42a formed on the outer sleeve surface. The outer bearing sleeve 41 is placed in cavity bore 43 such that flange surface 44 rests on the top of surface of suspension arm 45. A conventional threaded nut fastener 46 with matching thread 42b is placed, turned and tightened to secure the outer bearing sleeve 41 to the suspension arm 45. FIG. 5b is an inverted view of FIG. 5a shown only for clarity purposes.

In summary, a bearing assembly that is joined to an actuator suspension arm of a hard disk drive includes an actuator suspension arm that is stamped from a metal having a top and bottom surface and a threaded bore means defining an actuator axis of rotation. A bearing cartridge includes a reduced mass outer sleeve, the outer sleeve having an upper cylindrical member with a flanged lower member, the upper cylindrical member is threaded to engage with the threaded bore means of the suspension arm. The reduced mass outer sleeve has an internal spacer member to separate the outer races of conventional duplex bearings.

While the invention has been particularly shown and described with reference to the preferred embodiments thereof, it will be understood by those skilled in the art that various changes in form and details may be made without departing from the spirit and scope of the invention.

What is claimed is:

1. A bearing assembly that is joined to an actuator suspension arm of a hard disk drive, comprising:
an actuator suspension arm that is stamped from a metal, said suspension arm having a top and bottom surface and a threaded bore means defining an actuator axis of rotation;
a bearing cartridge with a reduced mass outer sleeve, said outer sleeve having an upper cylindrical member with a flanged lower member, said upper cylindrical member is threaded to engage with said threaded bore means of said suspension arm;
said outer sleeve having an internal spacer member.

2. The bearing assembly of claim 1 wherein said actuator suspension arm is stamped from a metal selected from the group consisting of aluminum or steel.

3. The bearing assembly of claim 1 wherein said lower flange of said outer sleeve is a limiting stop against said actuator suspension arm during engagement of said outer sleeve.

4. The bearing assembly of claim 1 wherein said internal spacer member separates the outer races of conventional duplex bearings.

5. The bearing assembly of claim 1 wherein a conventional internal bushing is used to receive a conventional pivot shaft that defines said actuator axis of rotation.

6. The bearing assembly of claim 5 wherein said conventional pivot shaft makes available means for securing said bearing assembly to said pivot shaft.

7. The bearing assembly of claim 1 wherein said assembly enables a lower cost structure for low cost entry level hard disk drives.

8. A bearing assembly that is joined to an actuator suspension arm of a hard disk drive, comprising:
an actuator suspension arm that is stamped from a metal, said suspension arm having a top surface separated from a bottom surface and a bore means defining an actuator axis of rotation;
a bearing cartridge with a reduced mass outer sleeve, said outer sleeve having an upper flanged end and a lower cylindrical end;
said lower cylindrical end having a groove formed on its diameter;
said lower cylindrical end slidely engages into said bore means, there-after, said upper flange end resting on said top surface of said actuator suspension arm;
a retaining ring is inserted in said groove therein securing said bearing to said actuator suspension arm.
said outer sleeve having an internal spacer member.

9. The bearing assembly of claim 8 wherein said actuator suspension arm is stamped from a metal selected from the group consisting of aluminum or steel.

10. The bearing assembly of claim 8 wherein said upper flange of said outer sleeve is a limiting stop against said top surface of said actuator suspension arm after engagement of said outer sleeve.

11. The bearing assembly of claim 8 wherein said internal spacer member separates the outer races of conventional duplex bearings.

12. The bearing assembly of claim 8 wherein a conventional internal bushing is used to receive a conventional pivot shaft that defines said actuator axis of rotation.

13. The bearing assembly of claim 12 wherein said conventional pivot shaft makes available means for securing said bearing assembly to said pivot shaft.

14. The bearing assembly of claim 12 wherein said assembly enables a lower cost structure for low cost entry level hard disk drives.

15. A bearing assembly that is joined to an actuator suspension arm of a hard disk drive, comprising:
an actuator suspension arm that is stamped from a metal, said suspension arm having a top surface separated from a bottom surface and a bore means defining an actuator axis of rotation;
a bearing cartridge with a reduced mass outer sleeve, said outer sleeve having an upper flanged end and a lower cylindrical end;
said lower cylindrical end having a thread formed on its diameter;
said lower cylindrical end slidely engages into said bore means, there-after, said upper flange end resting on said top surface of said actuator suspension arm;
a conventional nut fastener secures said reduced mass outer sleeve to said actuator suspension arm.
said outer sleeve having an internal spacer member.

16. The bearing assembly of claim 15 wherein said actuator suspension arm is stamped from a metal selected from the group consisting of aluminum or steel.

17. The bearing assembly of claim 15 wherein said upper flange of said outer sleeve is a limiting stop against said top surface of said actuator suspension arm after engagement of said outer sleeve.

18. The bearing assembly of claim 15 wherein said internal spacer member separates the outer races of conventional duplex bearings.

19. The bearing assembly of claim 15 wherein a conventional internal bushing is used to receive a conventional pivot shaft that defines said actuator axis of rotation.

20. The bearing assembly of claim 19 wherein said conventional pivot shaft makes available means for securing said bearing assembly to said pivot shaft.

21. The bearing assembly of claim 15 wherein said assembly enables a lower cost structure for low cost entry level hard disk drives.

22. A method for attaching bearings to single head hard disk drives, comprising the steps of:
providing an actuator suspension arm that is stamped from a metal, said suspension arm having a top and bottom surface and a threaded bore means defining an actuator axis of rotation;
providing a bearing cartridge with a reduced mass outer sleeve, said outer sleeve having an upper cylindrical member with a flanged lower member, said upper cylindrical member is threaded to engage with said threaded bore means of said suspension arm;
said outer sleeve having an internal spacer means.

23. The method of claim 22 wherein said actuator suspension arm is stamped from a metal selected from the group consisting of aluminum or steel.

24. The method of claim 22 wherein said upper flange of said outer sleeve provides a limiting stop against said top surface of said actuator suspension arm after engagement of said outer sleeve.

25. The method of claim 22 wherein said internal spacer member provides separation between the outer races of conventional duplex bearings.

26. The method of claim 22 wherein a conventional internal bushing is provided to receive a conventional pivot shaft that defines said actuator axis of rotation.

27. The method of claim 22 wherein said assembly enables a lower cost structure for low cost entry level hard disk drives.
